(19) United States
(12) Patent Application Publication
(10) Pub. No.: US 2014/0283596 A1
(43) Pub. Date: Sep. 25, 2014

(54) Humidity Detection Device

(71) Applicant: Hitachi Automotive Systems, Ltd., Hitachinaka-shi, Ibaraki (JP)

(72) Inventors: Takeo Hosokawa, Hitachinaka (JP); Takayuki Saito, Hitachinaka (JP)

(21) Appl. No.: 14/353,581

(22) PCT Filed: Oct. 3, 2012
(86) PCT No.: PCT/JP2012/075595

§ 371 Date: Apr. 23, 2014

(30) Foreign Application Priority Data
Oct. 28, 2011 (JP) 2011-236608

(51) Int. Cl. G01N 25/56

(52) U.S. Cl. CPC G01N 25/56
USPC 73/335.02

(57) ABSTRACT

To provide a humidity detection device by which good accuracy in measurement is achieved even under severe environmental conditions, in the humidity detection device which includes an electronic circuit board 1 and a humidity detection element 2 mounted on one surface of the electronic circuit board and detects humidity in air by exposing to air the whole of the humidity detection element and a portion of the electronic circuit board, a plurality of heating resistors 3 are mounted on the same surface as the surface on which the humidity detection element is mounted, and the heating resistors are provided around the humidity detection element.

### TECHNICAL FIELD

The present invention relates to detection devices and in particular to a detection device suitable for temperature-humidity measurement of air taken in an internal combustion engine.

### BACKGROUND ART

There are macromolecular electric capacitance humidity sensors in which a sensor element made of macromolecules is formed on a substrate and the humidity of the atmosphere is measured from a variation in the electric capacitance value of the sensor element. This humidity sensor can detect humidity up to low level humidity and is relatively superior in precision and inexpensive. Thus, the humidity sensor has been used as an atmospheric humidity detection sensor in a wide range from consumer-use to industrial-use measuring instruments.

As for the automobile industry, there are sensors that include a humidity detection device or the like integral with e.g. an intake air flow measurement device for an internal combustion engine, with the sensors being capable of measuring a plurality of physical quantities. Patent document 1 discloses an example in which the humidity measuring device and the pressure measuring device are made integral with each other.

Further, patent document 2 discloses an example of a humidity sensor which is provided with a heating portion in order to suppress dew condensation on the humidity sensor.

### PRIOR-ART DOCUMENTS

### Patent Documents

Patent document 1: JP-2010-43883-A

Patent document 2: JP-2002-39983-A

### SUMMARY OF THE INVENTION

### Problem to be Solved by the Invention

Currently, automobiles using an electronic control fuel injection system are popular. Such automobiles have a variety of sensors and control units arranged inside the engine room. Along with this, the number of the electrical components is increased and thus reducing the power consumption of respective electronic devices becomes one issue.

One of the electronic devices is a humidity detection device. More recently, the humidity detection devices have just started to be adopted for use in fuel control application although they have mainly been used for controlling air conditioning in a cabin. For use in the cabin, durability or the like against severe environment as expected is not required of the humidity detection devices. For use in fuel control application, however, when the humidity detection devices are used integrally with an intake air flow measurement device or other sensors installed in an internal combustion engine, they need to have environmental resistance equivalent to that of the intake air flow measurement device.

The humidity detection device deteriorates in measuring accuracy due to an adhesion of contaminants or water drops to a humidity detection element portion and further due to an influence of the environment under which these adhesions occur in a combined manner. Therefore, taking specific countermeasures against these phenomena becomes essential.

When the humidity detection device is used under severe environment as in an internal combustion engine, it is possible to suppress dew condensation by use of the conventional technology disclosed in patent document 2. However, for the conventional technology no attention is paid to suppressing contaminants such as carbon and the like. As pointed out by patent document 2, if the environment around the humidity detection element abruptly changes and the dew point is reached, then a problem occurs in which dew condensation will be formed on the humidity detection element.

Further, if the contaminants floating in the atmosphere, which contain the above-mentioned carbon, adhere to the vicinity of the humidity detection element, then dew condensation and the like occur in a combined manner because the contaminant per se has moisture absorbency. In case high-humidity air flows in, the contaminants absorb moisture in the high-humidity air, and thereby a measurement accuracy-related problem occurs in which the humidity detection element continues to detect humidity higher than that in actual environment during the time until the moisture dries.

It is an object of the present invention to provide a humidity detection device by which good accuracy in measurement is achieved even under severe environmental conditions.

### Means for Solving the Problem

To solve the above problem, a humidity detection device of the present invention includes a humidity detection element mounted on an electronic circuit board and a plurality of heating resistors mounted on the same surface of the electronic circuit board as a surface on which the humidity detection element is mounted.

### Effect of the Invention

The present invention can provide the humidity detection device by which good accuracy in measurement is achieved even under severe environmental conditions.

### BRIEF DESCRIPTION OF THE DRAWINGS

FIG. 1 is a plan view illustrating a first embodiment of the present invention.

FIG. 2 is a plan view illustrating another embodiment of the present invention.

FIG. 3 is a plan view illustrating another embodiment of the present invention.

FIG. 4 is a plan view illustrating another embodiment of the present invention.

FIG. 5 is a cross-sectional view illustrating one embodiment which makes use of the present invention for a humidity sensor.

### MODE FOR CARRYING OUT THE INVENTION

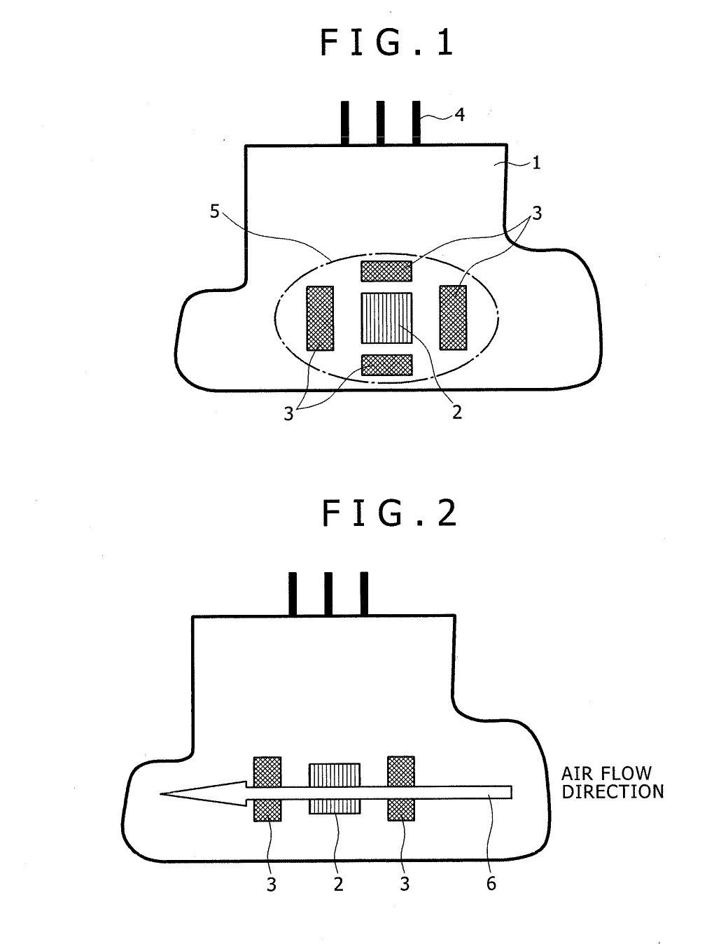

A specific configuration of the present invention will be described by way of example with reference to FIG. 1.

A humidity detection element 2 is mounted on an electronic circuit board 1. Further, the electronic circuit board 1 has an input-output terminal 4 used for input and output with the outside. Humidity detection using these components is attained by attaching the whole of the humidity detection element 2 and a portion of the electronic circuit board 1 to an intake pipe so as to come into direct contact with the air flowing in the intake pipe.

Heating resistors 3 are mounted on the electronic circuit board 1, specifically, on the same surface as a surface on which the humidity detection element 2 is mounted, at a position around the humidity detection element 2. In this way, not the whole of the electronic circuit board 1 but only a portion corresponding to the humidity detection element 2 is locally heated to thereby define a heated area 5 on the front surface of the electronic circuit board 1. With this configuration, only the circumference of the humidity detection element 2 can efficiently be heated at low power consumption, which allows for countermeasures against dew condensation.

Further, because of the local heating, a difference in temperature becomes largest in the vicinity of the boundary of the heated area 5. By using the characteristics in which contaminants floating in the air move toward the low-temperature side in this temperature difference, the contaminants are allowed to adhere intentionally to the outer circumferential portion of the heated area 5.

For example, if the whole of the electronic circuit board 1 is heated uniformly, it becomes impossible to make the above-mentioned temperature difference on the board. Therefore, the contaminants in air will adhere uniformly to the board, and also to the humidity detection element 2 per se. When dew condensation occurs in a combined manner, the contaminants absorb moisture, which leads to the occurrence of a humidity measurement error.

However, the present configuration can prevent dew condensation and contamination and additionally allow contaminants to adhere to a place away from the humidity detection element 2. Therefore, it is possible to prevent the occurrence of a humidity measurement error.

As in the present configuration, the heating resistors 3 are mounted at four positions so as to surround the circumference of the humidity detection element 2. Therefore, a temperature distribution has a symmetric property with reference to the humidity detection element 2 even in a flow field in which air flow directions may occur in a random manner. Thus, the humidity detection element 2 can maintain its performance without being influenced by the air flow.

Another embodiment is next described with reference to FIG. 2. The same configurations as in the previous embodiment are denoted with like reference numerals and their explanations are omitted.

As illustrated in FIG. 2, unlike the previous embodiment, a humidity detection device of the present embodiment is configured such that heating resistors 3 are installed one by one in the upstream and in the downstream of an air flow with respect to the humidity detection element 2. More specifically, in a case where the configuration or mounting method of the present humidity detection device may enable an air flow moving around the humidity detection element 2 to move in one axial direction, the heating resistors 3 are respectively mounted in the upstream and in the downstream of the air flow with respect to the humidity detection element 2. In this way, the number of the heating resistors 3 thus mounted can be reduced to achieve a further reduction in power consumption and also the overall device can be reduced in size and in weight. In addition, the area of a portion to which intake air contacts can be reduced; therefore, a reduction in air resistance resulting from the mounting of the present device can be enabled.

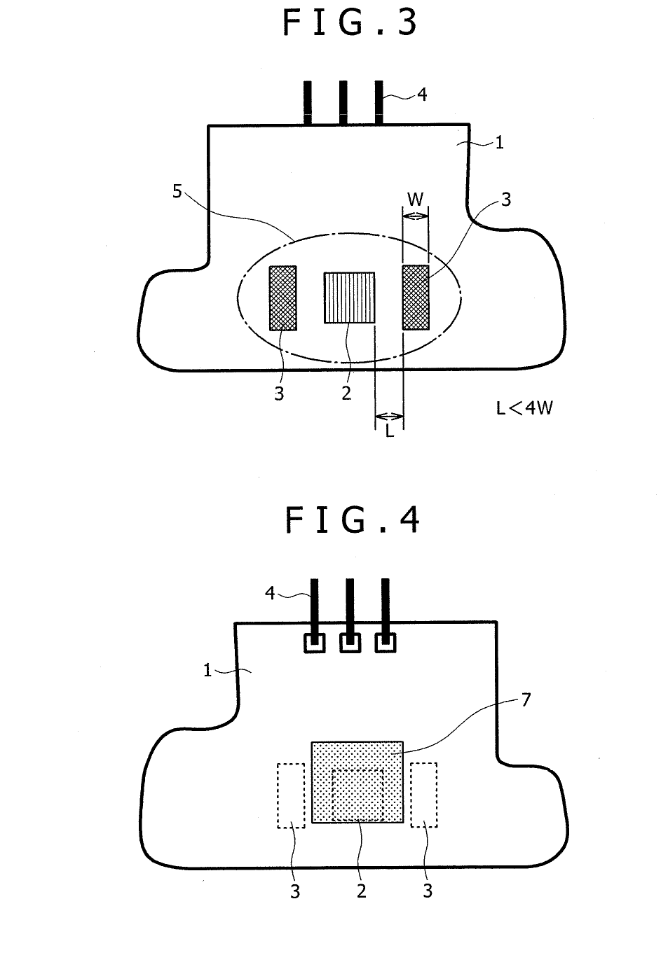

Still another embodiment is described with reference to FIG. 3. The same configurations as in the previous embodiment are denoted with like reference numerals and their explanations are omitted.

In the present embodiment, the mounting-positional relationship between the humidity detection element 2 and the heating resistor 3 is defined in relation to the configuration illustrated in FIG. 2. More specifically, when a distance between the humidity detection element 2 and the heating resistor 3 is set at L and when a length of a short side of the heating resistor 3 is set at W, the humidity detection element 2 and the heating resistor 3 are mounted so that a relationship of L<4W is satisfied. In the heated area 5, a portion farther from the humidity detection element 2 as much as possible is advantageous against a measurement error resulting from contamination or from moisture absorbed by contaminants. On the other hand, if the two heating resistors 3 are mounted while keeping away too much from each other, a temperature area, i.e., low-temperature area prevails at a portion of the humidity detection element 2 lying midway between the two heating resistors 3, so that contaminants are likely to adhere to the portion of the humidity detection element 2. To eliminate such a disadvantage, the distance L between the humidity detection element 2 and the heating resistor 3 is set to 3W, further by taking into account the calorific amount of the heating resistor 3, the distance between the humidity detection element 2 and the heating resistor 3 is set to about 4W at a maximum. By doing so, the humidity detection device can be provided that can achieve the objective against contaminants per se.

Yet another embodiment is described with reference to FIG. 4. The same configurations as in the previous embodiments are denoted with like reference numerals and their explanations are omitted.

In the present embodiment as illustrated in FIG. 4, another electronic component 7 constituting a part of the humidity detection device is mounted on a surface, of the electronic circuit board 1, opposite to the surface on which the humidity detection element 2 and the heating resistors 3 are mounted. Additionally, also the input-output terminal 4 is mounted on the same surface as the surface on which the other electronic component 7 is mounted.

With this configuration, a measurement surface which is directly exposed to intake air for measurement can be separated from an electronic circuit surface which needs to be protected from external environments. Therefore, usability is improved and further, the mounting and attachment of the present device can be enabled because of the simple circumferential configuration.

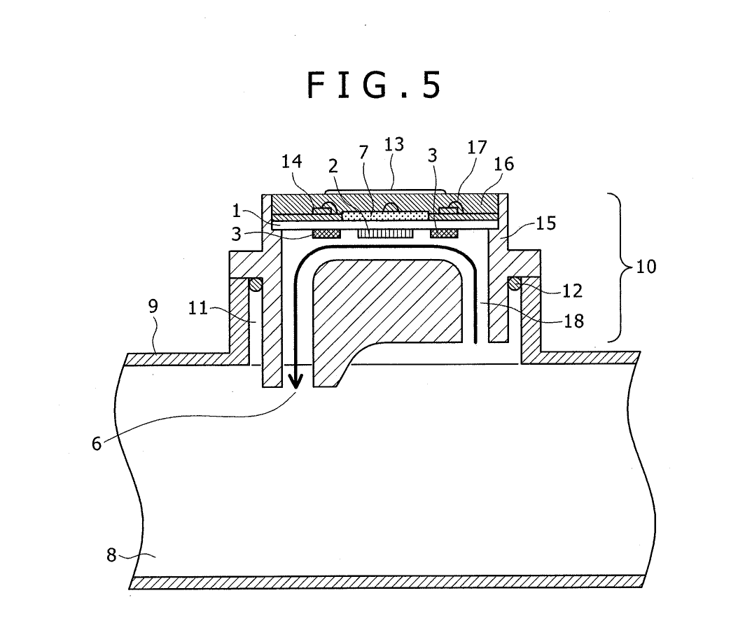

Lastly, one example which uses the present invention as the humidity detection device for an internal combustion engine is described with reference to FIG. 5.

An intake pipe constituting member 9 which constitutes a main passage 8 is provided with an attachment hole 11 for a humidity sensor 10. The humidity sensor 10 is attached to the attachment hole 11 via a seal member 12 such as an O-ring or the like.

The humidity sensor 10 is configured as below. A housing member 15 which is formed integrally with a connector 13 and connector terminals 14 is provided as a base. An electronic circuit board 1 on which a humidity detection element 2, heating resistors 3 and another electronic component 7 are mounted is internally mounted on the base. A coating material 16 such as a cast resin is poured from the side where the other electronic component 7 is mounted. Electric connection between the connector terminals 14 and the electronic circuit board 1 is performed by means of metal wires 17. This enables input from and output to the outside via the connector 13. The housing member 15 is formed with a sub-passage 18 to take in a portion of intake air flowing in the main passage 8. The humidity detection element 2 and the heating resistor 3 can perform measurement by coming into direct contact with the air flowing in the sub-passage 18. Further, an air flow direction 6 is limited to one axis by the sub-passage 18. Therefore, the heating resistors 3 which need to be mounted are limited to a location in the upstream and a location in the downstream of the humidity detection element 2.

The present device can achieve the aim, at low power consumption, against deterioration in measurement accuracy resulting from contamination, dew condensation, or the combined occurrence of contamination and dew condensation. The humidity detection device can be provided which is superior in quality and in performance and most suitable for use in an internal combustion engine.

### Explanation of Reference Numerals

1 Electronic circuit board
2 Humidity detection element
3 Heating resistor
4 Input-output terminal
5 Heated area
6 Air flow direction
7 Another electronic component
8 Main passage
9 Intake pipe constituting member
10 Humidity sensor
11 Attachment hole
12 Seal member
13 Connector
14 Connector terminal
15 Housing member
16 Coating material
17 Metal wire
18 Sub-passage

1. A humidity detection device comprising an electronic circuit board and a humidity detection element mounted on one surface of the electronic circuit board, the humidity detection device detecting humidity in air by exposing to air the whole of the humidity detection element and a portion of the electronic circuit board,
wherein a plurality of heating resistors are mounted on the same surface as the surface on which the humidity detection element is mounted, and
the heating resistors are provided around the humidity detection element.

2. The humidity detection device according to claim 1,
wherein at least one of the plurality of heating resistors is provided on each of the upstream and downstream sides of an air flow with respect to the humidity detection element.

3. The humidity detection device according to claim 2,
wherein if it is assumed that a distance between the humidity detection element and the heating resistor is set at L and a width of the heating resistor is set at W, the humidity detection element and the heating resistor are arranged to satisfy a relationship of L<4W.

4. The humidity detection device according to claim 1,
wherein other electronic component is mounted on the other surface opposite to the surface on which the humidity detection element and the heating resistor are mounted.

5. The humidity detection device according to claim 4,
wherein the other surface, of the electronic circuit board, on which the other electronic component is mounted is covered with a coating material.
